(19) United States
(12) Patent Application Publication
(10) Pub. No.: US 2013/0215703 A1
(43) Pub. Date: Aug. 22, 2013

(54) METHOD OF SIMULTANEOUS ULTRASONIC CAVITATION TREATMENT OF LIQUID MEDIUM HAVING CONTRASTING COMPOSITIONS

(71) Applicants: Andrej Getalov, Moscow (RU); Evgeny Dedyukhin, Kazan (RU); Marat Giniyatullin, Kazan (RU); Aleksandr Sirotkin, Kazan (RU)

(72) Inventors: Andrej Getalov, Moscow (RU); Evgeny Dedyukhin, Kazan (RU); Marat Giniyatullin, Kazan (RU); Aleksandr Sirotkin, Kazan (RU)

(21) Appl. No.: 13/813,506

(22) PCT Filed: Oct. 3, 2011
(86) PCT No.: PCT/RU2011/000771

§ 371 Date: May 8, 2013

(30) Foreign Application Priority Data
Aug. 29, 2011 (RU) 2011135703

(51) Int. Cl. B01F 11/02

(52) U.S. Cl. CPC B01F 11/0283
USPC 366/116

(57) ABSTRACT

The present invention refers to the field of cavitation treatment of liquid medium as well as the medium having the density of water or other liquid body is more than 65-70% of total mass. Method of simultaneous ultrasonic cavitation treatment of liquid mediums having different compositions is what volumes of any kind are placed in the channel system with the liquid where the plain standing acoustic wave, passing the holding capacities, primary, in perpendicular position, is generated; the material of the holding capacities has the specific acoustic impedance equal to or similar to the specific acoustic impedance of the liquid filling the channel system and the impedance of the treated liquid medium; the amplitude of ultrasonic resonant vibrations exceeds the acoustic cavitation threshold for liquid mediums is being treated at the moment taking into account the transmission losses while passing the walls of holding capacity; the optimum temperature of liquid mediums treatment is given due to the liquid in the channel system. The method allows simultaneously to conduct ultrasonic cavitation treatment of liquid mediums having contrasting compositions and at the same time to maintain the required temperature conditions.

### CROSS REFERENCE TO RELATED APPLICATION

This application is for entry into the U.S. National Phase under §371 for International Application No. PCT/RU2011/000771 having an international filing date of Oct. 3, 2011, and from which priority is claimed under all applicable sections of Title 35 of the United States Code including, but not limited to, Sections 120, 363 and 365(c), and which in turn claims priority to Russian National Application RU 2011135703 filed on Aug. 29, 2011.

### BACKGROUND OF THE INVENTION

The nearest equivalent method is the method of obtaining of emulsion cosmetic preparation according to Application No. 2010137176 of Sep. 8, 2010, the positive decision of ROSPATENT of Mar. 22, 2011, No. 2010137176/15(052870).

Brightening of vibrational amplitude of acoustic wave in the treated liquid medium is effected by resonance cophasal vibrations of each bigger side of channel system having rectangular cross-section and additional superposition of waves inside the channel, at that inside distance is equal to the small side of channel and is multiple of quarter of acoustic wave length in the treated medium. It takes the opportunity to centralize maximum energy on resonant vibrational frequency of the bigger side of the channel and obtain a standing acoustic wave of high intensity inside the channel.

The research carried out by the company “ DERMANIKA” indicated that dominant mode of dispercity in such process of treatment can be ˜500 nanometers and less, the emulsion does not practically include dispersion phase with the dimensions more than 1000 nanometers (1 micron), the proportion of emulsifier in the emulsion is twice or thrice less than usual. At that rotor-pulsing homogenizers take an opportunity to obtain emulsions with the dimensions of disperse phase beginning from 1000 nanometers (1 micron) and more with the more proportion of emulsifier /2/.

This research was reported at the XIV International Research and Practice conference “Cosmetic preparations and raw materials: safety and efficiency” held in October 2009, where it took second place and the diploma. There are also publications in specialized magazines/6/.

In such a case the quality of products upgrades in accordance with cavitation criteria (cavitation threshold) [3,4] and resonant mode of operation with the maximum efficiency and the best key figures on intensification of integrated physical-chemical, hydromechanical, heat-exchanging and mass-exchanging processes to the treated medium and the minimum size and homogeneity of oil phase (fat phase) recovered in the output.

This technology is implemented in commercial size in the acting cosmetic manufacturer “Closed Joint Stock Company Laboratory EMANSI”. Initial products produced according to this technological process is the hand cream Anti Smell Smoke (for smokers, against influence of nicotine and smoke to hand skin), which passed the total cycle of certification tests (Protocol of sanitary and healthcare inspection No.77.01.12.915.Π.006156.02.10 of Feb. 3, 2010) and statement of compliance confirmed by independent trials in laboratory “Spectrum” (accreditation certificate No ROSS RU.0001.21PSH50) with the corresponding test sheet No. 19 of Dec. 22, 2009.

However this technology has a number of limitations. For example, it is required to carry our simultaneous cavitation treatment of liquid mediums with contrasting composition by one channel or to proceed with batch treatment of minute steady-state (standing) volume of liquid mediums. It is also not possible to use one channel of standard dimensions in case it is required to obtain the final product in its output. In this case there is a lack of the linear length of the channel for aggregation of the required ultrasonication time and securing flow of the treated liquid. There is significant impediment as cavitation treatment of liquid medium with maintenance of the required temperature. It is known that while in cavitation treatment there is high-heat deposition and active heating of the treated liquid and thus, the effective heat transfer becomes a serious problem. In a number of instances temperature conditions of treatment of the whole volume of liquid is of first importance.

### SUMMARY

The present invention refers to the field of cavitation treatment of liquid medium as well as the medium having the density of water or other liquid body more than 65-70% of total mass. It is known that acoustic ultrasonic cavitation can be leveraged in different fields of economy implementing the following technological process /1-6/:
Dispergating;
Homogenization and emulsionizing;
Intermixing;
Disintegration;
Deagglomeration

As a matter of practice it covers process of producing of multi-component medium (emulsions, suspensions, aqueous solutions and systems), ultrasonic sterilization (antisepsis) of water, milk, other liquid products etc.

Method of treatment of liquid medium, being implemented in the scheme of the ultrasonic reactor can be taken as prototype/1/. This method consists in that the ultrasonic wave in liquid volume is generated by means of the rod reactor, in the abutting end of which there is a wave source usually being piezoelectric sender.

There are many of variants of estimation of the form of rod radiator and the possibility of mounting of several piezoelectric senders in its abutting end, but they all are focused on brightening vibrations of the rod in the bottom abutting end and on the sideboards /8/.

This is due to the fact that the zone of super cavitation in practice is measured by size in centimeters from the surface of vibration. For this reason the but end of the rod is considered the most effective zone since conjunctional wave in the treated liquid is being formed between the flat abutting end of the radiator and the flat bottom. With that it should be noted that it is very difficult to make the diameter of the abutting end equal to the size more than 50-70 mm.

The radiation from cylindrical surface of the rod has substantially smaller vibrational amplitude and cylindrical divergence. Factored in the acoustic waves reflected from external cylinder body walls it can be estimated that it is not practically possible to obtain the optimum condition of standing plane coherent ultrasonic wave in the treated liquid medium by analogy with the nonthreatening field between abutting end of the radiating unit and the bottom of the cylinder body.

Multiplex pattern of transmitted and reflected ultrasonic waves in the medium, the absence of wave coherence and energy concentration at a single frequency lead to the fact that it is not practically possible to obtain emulsions with the size of dispersion phase less than ˜1.0 mkm, the homogeneity gauge is not in excess of 20% in the dominant mode. Thereat, the volume of the treated liquid is limited.

Another alternating method of ultrasonic cavitation treatment of liquid medium is put into practice in rotor-oscillatory.

It is realized in rotor-pulsing homogenizers/2/.

By means of periodically generated alternating motion of the fluid from the rotary system stator-rotor, in insonation camera ultrasonic wave bearing cavitation effects originates. This is an interim option between acoustic and hydrodynamic cavitation. At the present moment such homogenizers gain the maximal currency. They are unsophisticated enough, take the opportunity to treat substantial volume of liquid much less expensively than ultrasonic analogues.

Satisfactory fast-speed homogenizers take the opportunity to obtain emulsions with the size of dispersion phase ˜1.5 mkm in the dominant mode; the homogeneity gauge is not in excess of 12-15%. Nevertheless this method also has a number of essential restrictions due to poor coefficient of efficiency of electromechanical system (up to 10%) that sets a limit to the power of ultrasonic wave to 1.5-2 watt/square centimeter, not taking the opportunity to work upon viscous medium and treatment of static liquid volume (volume stator-rotor) as well as a number of other significant limitations.

### BRIEF DESCRIPTION OF THE DRAWINGS

FIG. 1 provides a representation one of the number of possible variants of implementation of the subject method.

FIG. 2 provides a representation of foil stripes placed in the plastic glasses before cavitation.

FIG. 3 provides a representation of foil strips after the cavitation.

### DETAILED DESCRIPTION

The aim of invention is securing the possibility of simultaneous ultrasonic cavitation treatment of contrasting composition liquid mediums with the securing the required temperature conditions. This aim is accomplished by the fact that the holding capacities with the treated liquid mediums having contrasting compositions are placed in the channel-system with the liquid where the standing acoustic wave, passing the holding capacities in perpendicular position, is generated. The material of the holding capacities has the specific acoustic impedance equal to or similar to the specific acoustic impedance of the liquid filling the channel system and the impedance of the treated liquid medium. The amplitude of ultrasonic resonant vibrations exceeds the acoustic cavitation threshold for liquid mediums being treated at the moment taking into account the transmission losses while passing the walls of holding capacity. The optimum temperature of liquid mediums treatment is given due to the liquid in the channel system. Here the channel clearance h is taken divisible by quarter-wavelength, exited in the channel liquid:

h=(k/4)*(C/f), k=1,2,3,

where
f—frequencies of fundamental harmonic of standing wave of the channel wall, hz;
C—acoustic velocity in the multiphase medium, mps;
h—channel clearance, m;

In the designated method the holding capacities with the treated liquids can be manufactured by different ways—they can be flowing channels (tubes) or fixed tanks (bathes).

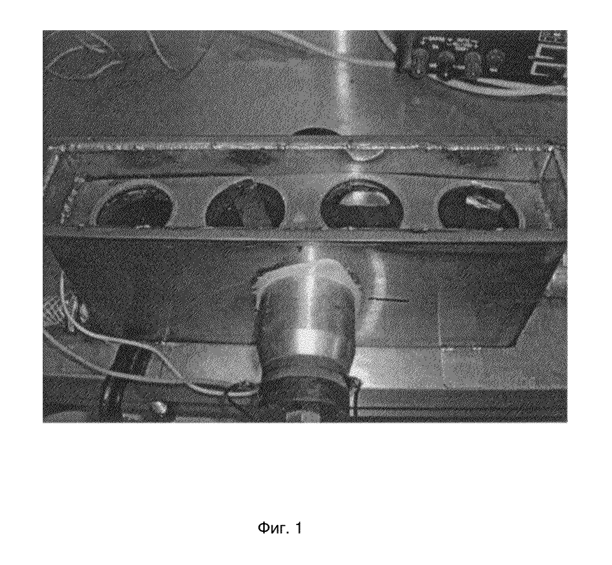

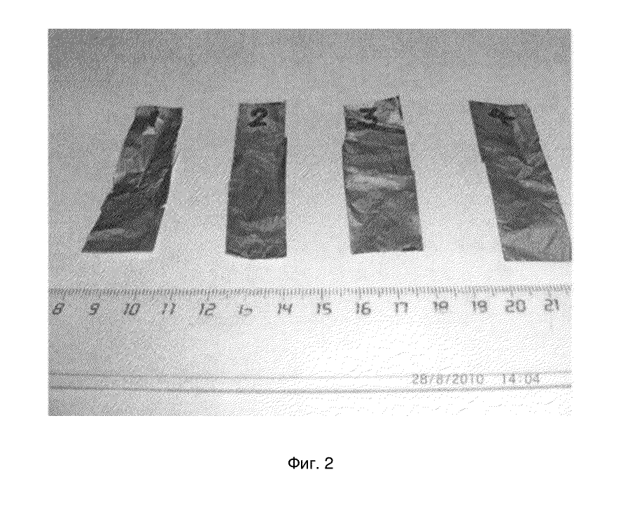

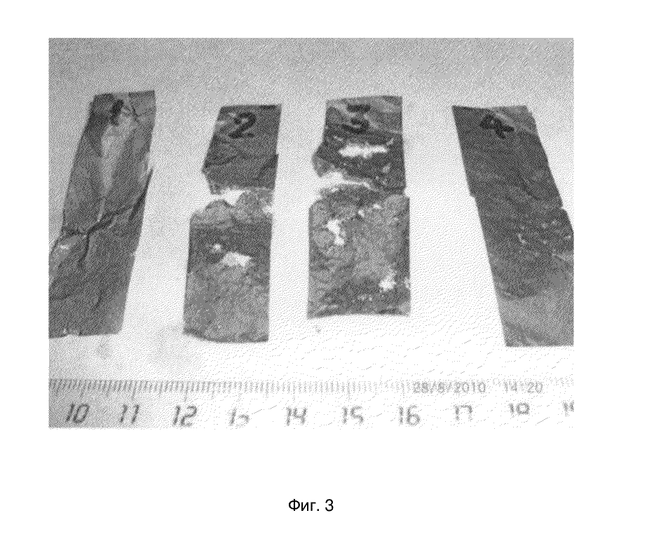

In FIG. 1 it is represented one of the number of possible variants of implementation of the subject method. The channel can simultaneously treat up to 4 different compositions. There is the opportunity to secure liquid flow in the channel and maintain the required temperature in the holding capacities. The treated liquid volumes are placed in the ordinary polyethylene glasses having the volume of 100 milliliters. Acoustic impedance of polyethylene (solidness 0.92-0.94 g/cm3, the velocity of dilatational wave about 1900-1950 m/c) differs from the impedance of water by about 16% and for practical evaluation of possible loses while ultrasonic wave transmission there carried out classical test illustrating the effect of cavitation on the foil stripe. In FIG. 2 and FIG. 3 there are represented foil stripes have been placed in the plastic glasses before and after the cavitation effect accordingly. The ultrasonication time was 60 seconds only, the vibrational frequency of the channel walls was 24.65 kilohertz, the power delivered to the transmitters was about 90 Watt being about 40% power of maximum possible long-lasting action power.

The width of the channel where the treated volumes of liquid were placed was 6 centimeters. That is equal to the length of the acoustic wave in water for this frequency.

The channel walls were the membranes with dimensions of 30 by 13 centimeters.

It is known that for the rectangular membrane with the fixed edges the solution of wave propagation after the setting of natural vibration frequencies to a fixed Cartesian coordinate system is given by/9,10/:

$$ω = c \sqrt{{k}_{x}^{2} + {k}_{y}^{2}} = c \sqrt{{( {j}_{x} \frac{π}{{L}_{x}} )}^{2} + {( {j}_{y} \frac{π}{{L}_{y}} )}^{2}} ,$$

where
c—the velocity of the waves over the plate;
kₓ, k_{y}—wave numbers, the value of which is defined by boundary conditions;
Lₓ,—lateral plate length, axially directed Ox;
L_{y}—lateral plate length, axially directed Oy;
jₓ, j_{y}—a whole number being equal to the number of antinodes lengthwise of the corresponding sides of the plate.

For obtaining peak recoil from the membrane it is required to implement the mode of vibration on the first mode, when the number of antinodes is equal to 1 in both coordinate directions. In this case all points of the membrane oscillate on the same frequency and phase with the maximum deflection in the center of the membrane.

For these dimensions of the channel walls the theoretical frequency is 24.4 kilohertz. In practice there are small departures from the calculated value, stipulated by the conditions of fixation on the verge, amount of deflection etc. /11/.

From FIG. 3 it can be seen that in practice the using of thin polyethylene as the material for placement of the holding capacities with the treated liquid is inexpensive and effective solution and acoustic loss can be neglected.

In the conducted tests in the channel there were placed two spiroid polyethylene tubes where through there were flashed two various liquids simultaneously being exposed to the effective cavitations treatment.

The important part of the tests was securing the required temperature conditions of the treated volumes of liquid. There were simultaneously prepared four volumes of various cosmetic creams in plastic glasses with the volume of each dose 80 ml. Homogenization of fat and aqueous phase within ten minutes there was provided a temperature of about 70 degrees due to the generated heat and the temperature of the water being in the channel. Further there was made water flushing and lowering of temperature to 43-45 degrees and maintaining thereof at this level. In addition, there were added active components and vitamin complex with homogenizing within ten further minutes.

At the last stage the temperature was lowered to 22-23 degrees that allowed cooling of cosmetic emulsion and obtaining the final product. It took about 30 minutes to complete the whole cycle of preparing products.

The results of stability, acid content and stringiness tests indicated the confluence of the obtained products to the requirements of regulatory documents.

Thus, the subject method of ultrasonic cavitation treatment of liquid mediums revealed the possibility of simultaneous treatment of different mediums having contrasting compositions as in flowing as in steady-state variant proving the possibility of applying of any treatment schedule. At that the temperature of the treated liquid mediums in the educed volumes can be maintained at the given level due to using liquid in the channel as coolant. The required technology cycle can be provided by fluid flow control in the channel and the temperature of the liquid.

1) (canceled)

2) A method of simultaneous ultrasonic cavitation treatment of a plurality of liquid mediums each having different compositions comprising the steps of:
placing a first of the plurality of liquid mediums into a first holding capacity;
placing the first holding capacity into a treatment channel, the channel forming a holder for the first holding capacity;
placing a second of the plurality of liquid mediums into a second holding capacity;
placing the second holding capacity into the channel, which forms a second holder for the second holding capacity;
selecting a fluid for vibration transmission, the fluid having an acoustic impedance similar or equal to a material of the first holding capacity and the second holding capacity;
filling, at least partially, the channel with the selected fluid;
vibrating a first membrane positioned on a first wall of the channel;
transmitting, using at least part of the first membrane, the vibration to the selected fluid within the channel;
transmitting the vibration from the selected fluid to the first and second holding capacity;
transmitting the vibration from the first and second holding capacity to the first and second of the plurality of liquid mediums, causing cavitatation of the first and second of the plurality of liquid mediums;
selecting a vibrational amplitude of the first membrane that exceeds the acoustic cavitation thresholds for the first and second of the plurality of liquid mediums, wherein the step of selecting comprises calculating transmission losses, and accounting for the calculated transmission losses; and
controlling a temperature of the first and second of the plurality of liquid mediums by controlling a temperature of the selected fluid in the channel.

3) The method of claim 2 further comprising the step of selecting the first and second of the plurality of liquid mediums to have a acoustic impedance equal to or similar to the selected fluid.

4) The method of claim 2 wherein the step of vibrating the first membrane comprises vibrating the first membrane at a harmonic of a fundamental frequency of the first membrane, thereby forming a standing wave on the first membrane.

5) The method of claim 2 further comprising the step of vibrating a second membrane positioned on a second wall of the flow channel a frequency of the second membrane being different from a frequency of the first membrane.

6) The method of claim 2 wherein the step of placing the first of the plurality of liquid mediums in the first holding capacity comprises placing the first of the plurality of liquid mediums in a first 100 ml glass; and
wherein the step of placing the second of the plurality of liquid mediums in the second holding capacity comprises placing the second of the plurality of liquid mediums in a second 100 ml glass.

7) The method of claim 2 wherein the step of controlling a temperature of the first and second of the plurality of liquid mediums comprises pumping the selected fluid through a chiller and back into the channel, the selected fluid being water.
